(19) United States
(12) Patent Application Publication
(10) Pub. No.: US 2015/0083251 A1
(43) Pub. Date: Mar. 26, 2015

(54) WATER DISPENSER

(71) Applicant: Kabushiki Kaisha Cosmo Life, Kakogawa-shi, Hyogo (JP)

(72) Inventor: Yoshinori Orita, Hyogo (JP)

(21) Appl. No.: 14/388,825

(22) PCT Filed: Mar. 27, 2013
(86) PCT No.: PCT/JP2013/058971

§ 371 Date: Sep. 29, 2014

(30) Foreign Application Priority Data
Apr. 2, 2012 (JP) 2012-083788

(51) Int. Cl. B67D 7/78

(52) U.S. Cl. CPC B67D 7/78
USPC 137/574

(57) ABSTRACT

A water dispenser includes a baffle which interferes with a downward flow of drinking water in a cold water tank which is fed from a raw water container through a raw water supply line, whereby cold water lower in temperature than drinking water above the baffle is generated below the baffle, and discharged. A recess is formed in the bottom surface of the baffle such that air trapped in the recess acts as a heat insulator between the baffle and the cold water. The baffle extends along the inner wall of the cold water tank with a gap defined therebetween, and includes a flange extending downwardly over the entire circumference thereof.

### TECHNICAL FIELD

The present invention relates to a water dispenser used to feed drinking water in a replaceable raw water container filled with drinking water such as mineral water.

### BACKGROUND ART

While older water dispensers were mainly used in offices and hospitals, due to increasing interest in safety of water and heath, a growing number of water dispensers are now used in ordinary homes. This type of water dispensers are typically configured such that drinking water in the raw water container is fed into the cold water tank, and the drinking water in the cold water tank is cooled by a cooling device.

In the cold water tank, the closer to the bottom of the tank, the lower the water temperature tends to be. Thus, a cold water discharge line is connected to the cold water tank so as to discharge cold water at the lower portion of the tank. When a lever or a cock is operated by a user, a valve provided at the boundary between the cold water tank and cold water discharge line opens, so that it is possible to discharge cold water into e.g. a glass. When water in the cold water tank decreases, drinking water is automatically fed into the upper portion of the cold water tank through a raw water supply line. If drinking water fed into the upper portion of the cold water tank should be allowed to smoothly flow down to the bottom of the cold water tank, this water would be quickly mixed with sufficiently cooled drinking water, thus raising the temperature of water at the bottom of the cold water tank, which would make it difficult to reduce energy consumption of the cooling device. To avoid this problem, a baffle is mounted in the cold water tank so as to interfere with a downward flow of drinking water just fed into the cold water tank. With this arrangement, drinking water in the cold water tank below the baffle is kept cold, i.e. colder than drinking water above the baffle so that cold water below the baffle can be discharged. (Such water dispensers are disclosed in e.g. the below-identified patent documents 1 to 3).

### PRIOR ART DOCUMENTS

### Patent Documents

Patent document 1: JP Patent Publication 2010-52752A (see especially FIG. 1)
Patent document 2: JP Patent Publication 2011-102154A (see especially FIG. 1)
Patent document 3: JP Patent Publication 2003-12092A (see especially FIGS. 1 and 2)

### OBJECT OF THE INVENTION

Today, saving electric energy at homes is considered important by a growing number of people. Water dispensers are also required to be more energy efficient.

An object of the present invention is to prevent cold water in the cold water tank of the water dispenser from being unnecessarily heated.

### Means for Achieving the Object

In order to achieve this object, a recess is formed in the bottom surface of the baffle such that air can be trapped in the recess and such that air trapped in the recess serves as a heat insulator between the baffle and cold water. With this arrangement, air trapped in the recess so as to be disposed between the baffle and the cold water under the baffle reduces heat transfer due to contact between cold water and the baffle, which is in contact with substantially normal-temperature drinking water, thus preventing cold water from being unnecessarily heated.

The positioning of the recess, the area ratio of the recess to the bottom surface of the baffle and the depth of the baffle are limited, provided air trapped in the recess serves as an insulator and can effectively reduce the temperature rise of cold water under the baffle. However, the area of the recess is preferably as large as possible to more effectively insulate heat.

Preferably, the baffle is provided with a plurality of water transfer passages configured such that drinking water above the baffle is introduced into the water transfer passages and discharged into the space below the baffle. If the radially outermost peripheral edge of the baffle is in fitting engagement with the inner wall of the cold water tank, or otherwise, if the horizontal gap therebetween is as small as possible, the area of the baffle, which partitions the interior of the cold water tank into upper and lower portions, can be increased to a maximum, so that drinking water above the baffle can be guided into the space below the baffle through the water transfer passages, while maximizing the ability of the baffle to interfere with the flow of water. By providing a plurality of the water transfer passages, it is possible to reduce the cross-sectional area of each water transfer passage, thereby reducing the momentum of water flow through each water transfer passage, which in turn allows drinking water to be discharged downward at a slower speed.

Air cannot be trapped at the same level as terminal ports of the water transfer passages. in the levels Thus, by providing the recess only at a higher level than the terminal ports so as to surround the water transfer passages, it is possible to easily increase the area ratio of the recess to the bottom surface of the baffle.

In order to minimize heat conductivity, and for better formability, the baffle is preferably made of a synthetic resin. In this case, in order to permit dimensional and assembling errors of the baffle and the cold water tank, thereby eliminating the costly measures of sealing between the baffle and the inner wall of the cold water tank with e.g. a soft packing material, a horizontal gap is preferably defined between the baffle and the inner wall of the cold water tank. If the baffle includes the water transfer passages, the horizontal gap need not be larger than is necessary to permit dimensional and assembling errors. While drinking water cannot practically flow down through such a narrow horizontal gap, air could pass through the horizontal gap. However, by arranging the baffle so as to extend along the inner periphery of the cold water tank with the horizontal gap defined therebetween, and providing the baffle with a flange extending downwardly over the entire circumference of the baffle, the flange prevents air trapped in the bottom surface of the baffle from escaping into the horizontal gap. This makes it possible to define the recess by the flange. By defining the recess by the flange, it is possible to maximize the area ratio of the recess to the bottom surface of the baffle, while efficiently using the circumference of the baffle.

The baffle may be supported in the cold water tank in an elevated position. By supporting the baffle on a single leg, it is possible to minimize the area ratio of the recess to the bottom surface of the baffle that is reduced by the leg. By providing the baffle to extend from the flange to the leg, it is possible to maximize the area ratio of the recess to the bottom surface of the baffle by most effectively utilizing the circumference of the baffle and the space between the leg and the flange.

### Advantages of the Invention

The present invention provides a water dispenser comprising a cold water tank in which drinking water fed from a raw water container through a raw water supply line is cooled, and a baffle configured to interfere with a downward flow of the drinking water fed into the cold water tank, wherein the baffle is configured such that cold water lower in temperature than drinking water in the cold water tank above the baffle is generated in the cold water tank below the baffle, and discharged, wherein a recess is formed in the bottom surface of the baffle such that air is trapped in the recess and such that the air trapped in the recess acts as a heat insulator between the baffle and the cold water. With this arrangement, it is possible to reduce heat conduction due to contact between cold water and the baffle, which is in contact with substantially normal-temperature drinking water, thus preventing the cold water in the cold water tank of the water dispenser from being unnecessarily heated.

### BRIEF DESCRIPTION OF THE DRAWINGS

FIG. 1 schematically shows an entire water dispenser embodying the present invention.

FIG. 2 is an enlarged view of a cold water tank of FIG. 1.

FIG. 3 is a bottom plan view of a baffle of the embodiment.

FIG. 4 is a front view of the baffle of FIG. 3.

FIG. 5 is a top plan view of the baffle of FIG. 3.

### BEST MODE FOR EMBODYING THE INVENTION

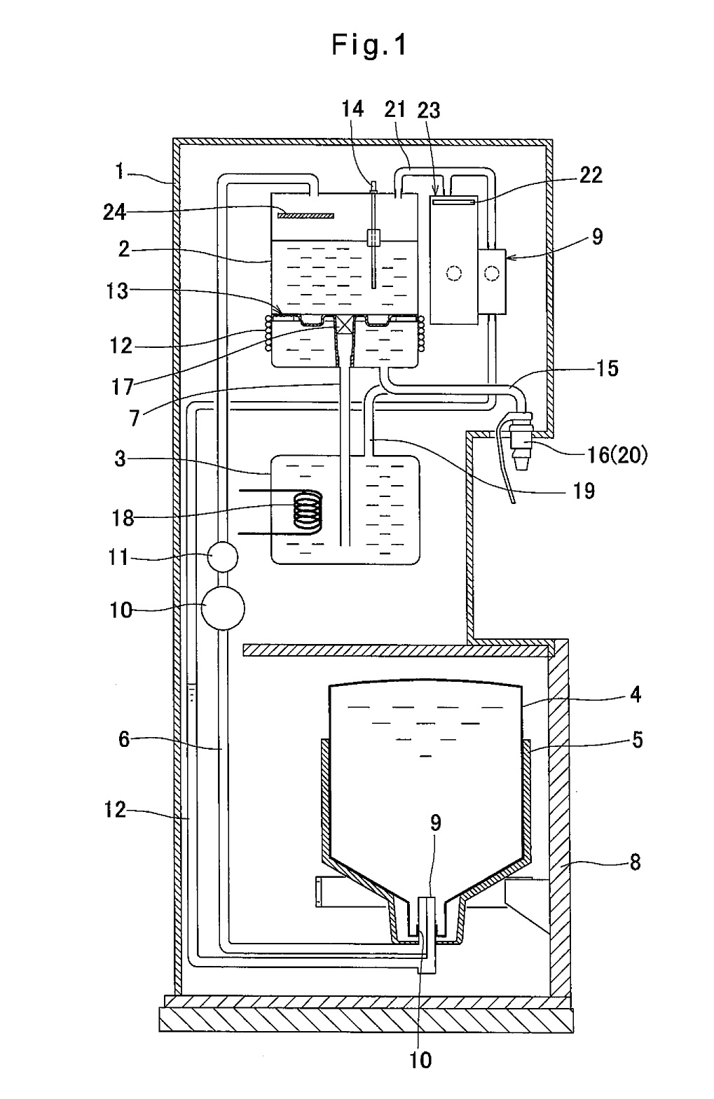

FIG. 1 shows a water dispenser embodying the present invention. The water dispenser includes a cold water tank 1 and a hot water tank 3 that are mounted in a casing 1, and a container holder 5 in which a replaceable raw water container 4 is set. When placed in the container holder 5, the raw water container 4 is connected to the cold water tank 2 through a raw water supply line 6. The cold water tank 2 is connected to the hot water tank 3 through a tank connecting line 7. The hot water tank 3 is located right under the cold water tank 2.

The raw water container 4 can hold up to 8 to 20 liters of water. In order that the raw water container 4 is easily replaceable with a new one, the container holder 5 is mounted on a slide table 8 horizontally slidably supported on the casing 1 and can be slid into and out of the casing 1. The raw water container 4 is placed in the container holder 5 with its water outlet facing downward. The container holder 5 is provided with a joint member 9 configured to be detachably connected to the water outlet of the raw water container 4. The joint member 9 includes a first end portion (end at the raw water container 4) of the raw water supply line 6, and a first end portion (end at the raw water container 4) of an air intake line 12 through which air is introduced into the raw water container 4. The raw water container 4 may be a soft container collapsible under the atmospheric pressure when water remaining in the container decreases, or may be a hard container not collapsible under the atmospheric pressure.

A pump 10 and a flow rate sensor 11 are provided at an intermediated portion of the raw water supply line 6. When the pump 10 is activated, drinking water in the raw water supply line 6 is moved from the raw water tank 4 toward the cold water tank 2, so that drinking water in the raw water container 4 is fed into the cold water tank 2. When water in the raw water supply line 6 runs out, air (containing ozone-containing air) in the raw water supply line 6 is moved from the raw water tank 4 toward the cold water tank 2. The flow rate sensor 11 is capable of detecting the fact that drinking water in the raw water supply line 6 has run out while the pump 10 is activated.

In the cold water tank 2, there are drinking water and air in two vertical layers. A cooling device 12 is mounted to the cold water tank 2 to cool drinking water in the cold water tank 2. A baffle 13 is mounted in the cold water tank 2 to partition the interior of the cold water tank 2 into upper and lower spaces. The cooling device 12 is mounted to the outer periphery of the cold water tank 2 at its lower portion to keep the portion of drinking water in the cold water tank 2 below the baffle 13 at a low temperature (about 0 to 10° C.) lower than the temperature of the water above the baffle 13 (about 15 to 25° C.), which is approximate to normal temperature.

A water level sensor 14 is mounted to the cold water tank 2, and measures the level of drinking water in the cold water tank 2. When the water level as measured by the water level sensor 14 falls to a predetermined value, the pump 10 is activated to feed drinking water in the raw water container 4 into the cold water tank 2. The baffle 13 prevents cold water that collects at the lower portion of the cold water tank 2 by being cooled by the cooling device 12 from being agitated by substantially normal-temperature drinking water that has just been fed from the raw water container 4 into the cold water tank 2.

A cold water discharge line 15 is connected to the bottom of the cold water tank 2 such that cold water that has collected at the lower portion of the cold water tank 2 can be discharged to the outside through the cold water discharge line 15. The cold water discharge line 15 carries a cold water cock 16 operable from outside the casing 1 such that by opening the cold water cock 16, low-temperature drinking water can be discharged from the cold water tank 2 into e.g. a cup. The capacity of the cold water tank 2 is smaller than that of the raw water container 4, and is about 2 to 4 liters.

In order to connect the cold water tank 2 to the hot water tank 3, the tank connecting line 7 has its top end open to the central portion of the baffle 13. The tank connecting line 7 extends vertically in a straight line between the bottom of the cold water tank 2 and the top of the hot water tank 3. The end portion of the tank connecting line 7 at the cold water tank 2 extends through the bottom of the cold water tank 2, further extends upwardly through the interior of the cold water tank 2, and is connected to the baffle 13. A check valve 17 is mounted in the end portion of the tank connecting line 7 at the cold water tank 2, and is configured to permit the flow of drinking water from the cold water tank 2 toward the hot water tank 3 and prohibit the flow of water from the hot water tank 3 toward the cold water tank 2.

As shown in FIG. 1, the hot water tank 3 is filled with drinking water. A heating device 18 is mounted to the hot water tank 3 to heat water in the hot water tank 3. The heating device 18 keeps drinking water in the hot water tank 3 at a high temperature (about 90° C.). The heating device 18 may e.g. a sheath heater or a band heater.

A hot water discharge line 19 is connected to the top of the hot water tank 3 such that high-temperature drinking water that has collected at the upper portion of the hot water tank 3 can be discharged to the outside through the hot water discharge line 19. The hot water discharge line 19 carries a hot water cock 20 operable from outside the casing 1 such that by opening the hot water cock 20, high-temperature drinking water can be discharged from the hot water tank 3 into e.g. a cup. When drinking water is discharged from the hot water tank 3, the same amount of drinking water as the amount of drinking water discharged flows from the cold water tank 2 into the hot water tank 3 through the tank connecting line 7. Thus, the hot water tank 3 is always filled with water. The hot water tank 3 can hold about 1 to 2 liters of water.

The tank connecting line 7 includes an in-tank pipe extending downwardly from the top surface of the hot water tank 3 through the interior of the hot water tank 3. The in-tank pipe has an open bottom end located in the vicinity of the bottom surface of the hot water tank 3 (vertically upwardly spaced apart from the bottom of the hot water tank 3 by not more than 30 mm), thereby preventing drinking water heated by the heating device 18 to high temperature and flowing upwardly in the hot water tank 3 from directly flowing into the in-tank pipe through its open bottom end.

In order to keep the interior of the cold water tank 2 at the atmospheric pressure when the water level in the cold water tank 2 falls, an air pipe 21 is provided through which the interior of the cold water tank 2 communicates with the atmosphere. The air pipe 21 extends through an air intake port 22 and an air sterilizing chamber 23 such that air sterilized in the air sterilizing chamber 23 can be introduced into the cold water tank 2. Air in the cold water tank 2 is therefore kept clean.

A dispersion plate 24 is provided in the cold water tank 2 to disperse drinking water flowing into the cold water tank 2 from the raw water supply line 6 by the time the water reaches the surface of the drinking water that has already been stored in the cold water tank 2. The dispersion plate 24 allows the drinking water discharged from the raw water supply line 6 to be brought into contact with ozone in the air (which has been introduced into the cold water tank 2 from the air sterilizing chamber 23) over a larger surface area, thus improving hygiene of the drinking water introduced into the cold water tank 2.

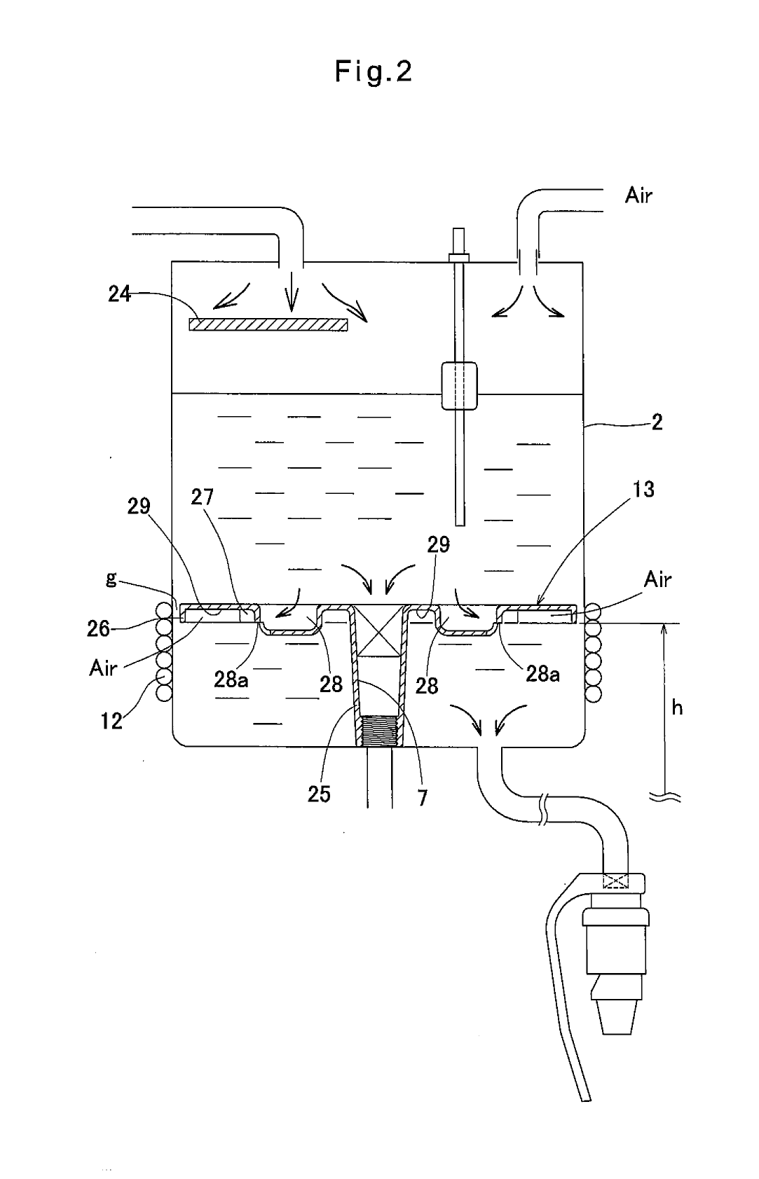

Referring to FIG. 2, the baffle 13, which interferes with the downward flow of drinking water that has fallen off the dispersion plate 24, is supported by a single leg 25 connected to the bottom surface of the baffle 13. The interior of the leg 25 serves as a portion of the tank connecting line 7. The leg 25 has its bottom end in threaded engagement with the end (at the cold water tank 2) of the portion of the tank connecting line 7 other than the leg 25, thereby keeping the baffle 13 at an intermediate level in the cold water tank 2.

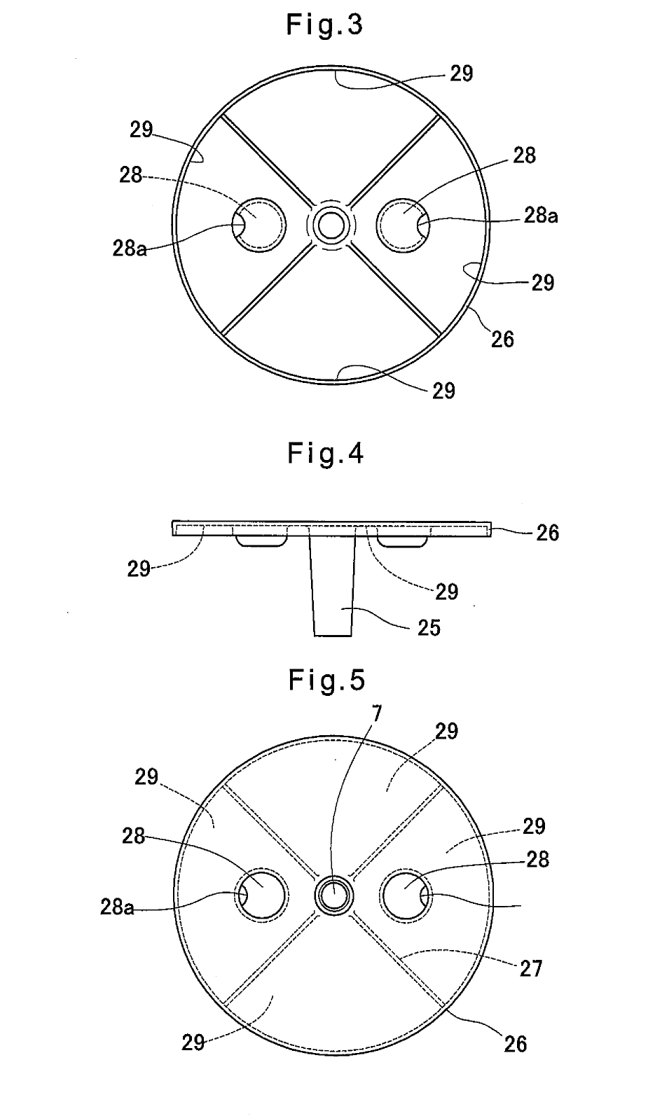

The portion of the baffle 13 that actually serves as a “baffle” is the annular portion extending from the opening of the tank connecting line 7 to the radially outermost peripheral edge of the baffle 13. This annular portion is on a single horizontal plane and thus at a uniform height. The radially outermost peripheral edge, which has the longest circumference of the baffle 13, is the horizontal limit beyond which the baffle 13 cannot interfere with downward flow of water. Referring to FIGS. 2 to 4, the baffle 13 has a flange 26 extending downwardly from the radially outermost peripheral edge over the entire circumference thereof, along the inner wall of the cold water tank 2 with a horizontal gap “g” left therebetween. The gap “g” serves to absorb errors such as dimensional errors and assembling errors, and is shown exaggerated in the drawings.

The baffle 13 is formed with ribs 27 on its bottom surface to prevent a fall of the flange 26 and the leg 25. The ribs 27 extend between the leg 25 and the flange 26 while being circumferentially equidistantly spaced apart from each other to circumferentially uniformly prevent a fall of the flange 26 and the leg 25.

Referring to FIGS. 2, 3 and 5, the baffle 13 has a plurality of water transfer passages 28 through which drinking water above the baffle 13 is introduced into the interior of the baffle 13 which is spaced apart from the radially outermost peripheral edge, and then discharged into the space below the baffle 13. By providing the water transfer passages 28 at the above-defined positions, it is possible to minimize the gap “g”.

The water transfer passages 28 are defined by flow passage walls recessed downwardly from the top surface of the baffle 13. The flow passage walls are each formed with a cutout facing horizontally and downwardly and defining a terminal port 28a of the water transfer passage 28. The water transfer passages 28 are configured such that drinking water above the baffle 13 is guided along the inner surfaces of the recessed flow passage walls to the respective terminal ports 28a and discharged through the terminal ports 28a so as to freely flow downward, which means that once water is discharged from the water transfer passages 28, it becomes impossible to control the water flow. The water transfer passages 28 are not limited to circular recesses as shown, but may e.g. be bent passages which each extend downwardly, upwardly and then downwardly to the terminal port, or any other flow passages. The water transfer passages 28 may be defined by members separate from the body of the baffle.

The terminal ports 28a of the respective water transfer passages 28 are arranged so as not to face each other. Thus, drinking water discharged downwardly from any terminal port 28a never collides head-on with drinking water discharged from the other terminal ports 28a, and thus flows smoothly downward. In the embodiment, in order to simplify the shape of the baffle 13, there are two of the water transfer passages 28 arranged diametrically opposite to each other and symmetrical to each other with respect to the center of the baffle 13. However, the number and the arrangement of the water transfer passages 28 are not limited. For examples, three or more of the water transfer passages 28 may be provided spaced apart from each other on a horizontal plane such that drinking water can be smoothly discharged from the respective terminal ports 28a.

The baffle 13 is formed with an upwardly extending recess 29 in the bottom surface thereof which is configured such that air is trapped therein and such that air trapped in the recess 29 is disposed between the baffle 13 and the cold water present below the baffle 13, thereby keeping the baffle 13 out of contact with the cold water. Thus, the air trapped in the recess 29 serves as a heat insulator that reduces heat conduction from the baffle 13, which is in contact with drinking water of a temperature approximate to normal temperature, to the cold water below the baffle 13, thereby preventing the cold water in the cold water tank 2 of the water dispenser from being unnecessarily heated.

The flow passage walls defining the respective water transfer passages 28 protrude from the bottom surface of the baffle 13, and have no openings other than the terminal ports 28a. The recess 29 extends upwardly from the highest points of the terminal ports 28a, and horizontally surrounds the portions of the water transfer passages 28 which are higher than the height “h” of the highest points of the terminal ports 28a. Thus, air in the recess 29 cannot escape upwardly into the space above the baffle 13 through the terminal ports 28a. As viewed from under the baffle 13, the recess 29 covers a large area of the bottom surface of the baffle 13, while surrounding the flow passage walls defining the water transfer passages 28.

The recess 29 extends from the flange 26 to the leg 25. The ribs 27 partition the recess 29 into portions surrounding the respective water transfer passages 28 and portions not surrounding the passages 28, thereby minimizing movement of air in the recess 29. Since there is only the single leg 25, it is possible to maximize the area of the recess 29 relative to the entire bottom surface of the baffle 13 by effectively using the circumference of the baffle 13 and the space between the leg 25 and the flange 26. The distal edge of the flange 26 is at a uniform height over the entire circumference thereof which is not higher than the highest points of the terminal ports 28a. With this arrangement, the recess 29 can trap a maximum amount of air, while minimizing the downward length of the flange 26. In order to eliminate any downwardly protruding portion of the flange 26 that does not contribute to trapping of air in the recess 29, the lowest point of the flange 26 is preferably determined at the same height as the highest points of the terminal ports 28a.

The baffle 13 shown is made of a synthetic resin, which is inferior in heat conductivity to metals. The synthetic resin used has to be sufficiently safe to human health and is preferably easily formed into the baffle 13. For this purpose, the synthetic resin used is an injection-moldable plastic, such as polypropylene (PP).

Now it is described how this water dispenser is used (referring sometimes to FIG. 1). Until the water dispenser is set up at a use location (in e.g. an ordinary home, an office or a hospital), the cold water tank 2 and the hot water tank 3 are both kept empty. In this state, the check valve 17 is moved downward by gravity, keeping the valve hole open. Thus, air can flow from the lower side of the check valve 17 (at the hot water tank 3) to the upper side of the check valve 17 (at the cold water tank 2) through the check valve 17.

After setting up the water dispenser at the use location, the replaceable raw water container 4 is connected to the water dispenser. Then, when the water dispenser is switched on, the pump 10 is activated, so that drinking water in the raw water container 4 is introduced into the cold water tank 2. As the water level in the cold water tank 2 rises as a result, excess air in the cold water tank 2 is expelled to the outside through the air pipe 21 and then through the air sterilizing chamber 23. At this time, a portion of air in the cold water tank 2 under the baffle 13 is trapped, and stays, in the recess 29.

When the water level in the cold water tank 2 exceeds the height of the baffle 13 (namely, the height of the end of the tank connecting line 7 at the cold water tank 2), drinking water in the cold water tank 2 is introduced into the hot water tank 3 through the tank connecting line 7. Simultaneously, air in the hot water tank 3 is discharged into the cold water tank 2 through the tank connecting line 7. In other words, drinking water in the cold water tank 2 is introduced into the hot water tank 3 through the tank connecting line 7 by replacing air in the hot water tank 3.

Thereafter, when the water level in the cold water tank 2 reaches a predetermined upper limit as shown in FIG. 1, the pump 10 is deactivated. In this state, drinking water in the cold water tank 2 is cooled to a low temperature by the cooling device 12, while drinking water in the hot water tank 3 is heated to a high temperature by the heating device 18.

Since the hot water tank 3 is located at a lower level than the cold water tank 2, and the drinking water in the hot water tank 3 is higher in temperature than the drinking water in the cold water tank 2, convection of drinking water occurs in the tank connecting line 7. However, the check valve 17 prevents drinking water in the hot water tank 3 from flowing into the cold water tank 2 due to convection of drinking water in the tank connecting line 7.

Referring to FIG. 2, since air is trapped in the plurality of partitioned portions of the recess 29, which is formed in the bottom surface of the baffle 13 and accounts for most of the bottom surface of the baffle 13, cold water under the baffle 13 contacts the baffle 13 only at the surface portions of the baffle 13 that are at heights lower than height h, including the leg 25, the flange 26, and the flow passage walls defining the water transfer passages 28. No heat is conducted from the remaining bottom surface portion of the baffle 13 to cold water under the baffle 13 because the former is kept out of contact with the latter. This prevents cold water in the cold water tank 2 of the water dispenser from being unnecessarily heated.

In this state, when a user operates the cold water cock, shown in FIG. 1, to discharge low-temperature drinking water in the cold water tank 2 into e.g. a cup, the water level in the cold water tank 2 falls. When a user operates the hot water cock 20 to discharge high-temperature drinking water in the hot water tank 3 into e.g. a cup, too, since the same amount of drinking water as the drinking water discharged flows from the cold water tank 2 into the hot water tank 3 through the tank connecting line 7, the water level in the cold water tank 2 falls. When the water level sensor 14 detects that the water level in the cold water tank 2 falls below a predetermined lower limit, the pump 10 is activated to feed drinking water in the raw water container 4 into the cold water tank 2. Since the lower limit of the water level is determined to be sufficiently higher than the highest point of the baffle 13, air in the recess 29 is never replaced with new air, and thus is kept at a low temperature.

The present invention is not limited to the above-described embodiment, but encompasses all modifications that are within the scope of the claims. For example, the present invention can be embodied in a water dispenser of which a raw water tank which stores normal temperature drinking water is provided above the cold water tank 2. The present invention is also applicable to a water dispenser including a raw water tank in which normal temperature drinking water is stored, a cold water tank and a hot water tank provided at the same level as each other and below the raw water tank, a tank connecting line for cold water through which the raw water tank is connected to the cold water tank, and a tank connecting line for hot water through which the raw water tank is connected to the hot water tank. The present invention is further applicable to a water dispenser in which the raw water container 4 is provided above the cold water tank 2 so that water in the raw water container 4 can be dropped into the cold water tank 2 through a short raw water supply line.

### DESCRIPTION OF THE NUMERALS

2. Cold water tank
4. Raw water container
6. Raw water supply line
13. Baffle
25. Leg
26. Flange
28. Water transfer passage
28a. Terminal port
29. Recess

1. A water dispenser comprising a cold water tank in which drinking water fed from a raw water container through a raw water supply line is cooled, and a baffle configured to interfere with a downward flow of the drinking water fed into the cold water tank, and
wherein the baffle is configured such that cold water lower in temperature than drinking water in the cold water tank above the baffle is generated in the cold water tank below the baffle, and discharged, and
wherein a recess is formed in a bottom surface of the baffle such that air is trapped in the recess and such that the air trapped in the recess acts as a heat insulator between the baffle and the cold water.

2. The water dispenser of claim 1, wherein the baffle is provided with a plurality of water transfer passages configured such that drinking water above the baffle is introduced into the water transfer passages and discharged into a space below the baffle,
wherein the water transfer passages have terminal ports, and
wherein the recess is provided at a higher level than the terminal ports, and surrounds the water transfer passages.

3. The water dispenser of claim 2, wherein the baffle is made of a synthetic resin,
wherein the baffle extends along an inner periphery of the cold water tank with a horizontal gap defined between the cold water tank and the inner periphery of the cold water tank,
wherein the baffle includes a flange extending downwardly over an entire circumference of the baffle, and
wherein the recess extends from the flange.

4. The water dispenser of claim 3, wherein the baffle is supported in position in the cold tank by a single leg extending from the bottom surface of the baffle, and is not supported by any member other than the leg, and
wherein the recess extends from the flange to the leg.
